(19) United States
(12) Patent Application Publication
(10) Pub. No.: US 2005/0287432 A1
(43) Pub. Date: Dec. 29, 2005

(54) Secondary battery

(76) Inventors: Sang-Eun Cheon, Suwon-si (KR); Dong-Keun Lee, Suwon-si (KR)

Correspondence Address: CHRISTIE, PARKER & HALE, LLP, PO BOX 7068, PASADENA, CA, 91109-7068, US

(21) Appl. No.: 11/159,544

(22) Filed: Jun. 22, 2005

(30) Foreign Application Priority Data
Jun. 23, 2004 (KR) 10-2004-0047022

(51) Int. Cl. H01M 2/26

(52) U.S. Cl. 429/161; 429/211; 429/94

(57) ABSTRACT

A secondary battery includes a case, an electrode assembly including a positive electrode, a negative electrode, and a separator interposed therebetween and housed in the case, and a cap assembly sealing the case and electrically coupled to the electrode assembly. A current collecting plate is electrically coupled to the positive electrode or the negative electrode, and is provided with an uncoated region, which does not include an active material, and which contacts the current collecting plate and is wider in the peripheral area of the electrode assembly than in the central area of the electrode assembly.

### CROSS REFERENCE TO RELATED APPLICATION

This application claims priority to and the benefit of Korean patent application No. 10-2004-0047022 filed in the Korean Intellectual Property Office on Jun. 23, 2004, the entire disclosure of which is incorporated herein by reference.

### FIELD OF THE INVENTION

The present invention relates to a secondary battery, and more particularly, to an electrode of an electrode assembly.

### BACKGROUND OF THE INVENTION

According to usage and battery capacity, secondary batteries are classified into low-capacity secondary batteries, which are referred to as “small batteries” hereinafter, that use a single battery cell packaged in the form of a pack, and high-capacity secondary batteries, which are referred to as “large batteries” hereinafter, that use scores of battery cells packaged into a battery pack for driving a motor.

Small batteries are used as the power source for small electronic devices, such as mobile phones, laptop computers, and camcorders, while large batteries are used as the power source for driving motors in hybrid electric vehicles and the like.

Depending on the external shape, small batteries may be classified into different types, such as square and cylindrical batteries. A small battery generally includes a positive electrode, a negative electrode, and a separator that is interposed as an insulator between the positive electrode and the negative electrode, that are spiral-wound to thereby form an electrode assembly. The electrode assembly is inserted into a cylindrical case to form the battery.

Each of the positive and negative electrodes of a secondary battery is provided with a conductive lead element for collecting current generated in positive and negative electrodes during the operation of the secondary battery. The lead element induces current generated in the positive and negative electrode to positive and negative terminals.

When a large battery is structured the same as a small battery, the operation characteristics of electric capacity and power output are not fulfilled. Therefore, a structure using a plurality of tabs attached to an electrode assembly has been suggested in Japanese Patent Laid-open No. 2003-7346. This battery has a plurality of tabs along one direction of an electrode assembly and the tabs are combined with an internal terminal, which is connected to an external terminal.

However, such a multi-tab structure is required for many working processes. The tab has a small unit area and thus is limited in satisfying required output power characteristics for large batteries.

Another form of a lead element is a current collecting plate. A current collecting plate has a wider unit area than the multi-tab structure. Therefore, it can have an improved current collecting efficiency and a high energy density per unit area by reducing the space occupied by the lead element, compared with tab resulting in an increase of energy density per unit volume.

The current collecting plate, however, has a shortcoming that the fixation between the current collecting plate and an electrode assembly is not firm. The current collecting plate is fixed to the electrode assembly by welding. In case that the electrode assembly has a jelly roll configuration, where positive and negative electrodes and a separator interposed therebetween are spiral-wound, and the current collecting plate is fixed to the electrode assembly, the contact area between the electrode assembly and the current collecting plate decreases from the interior of the electrode assembly toward the exterior. This results in an unstable weld-fixation at the exterior. Furthermore, welding heat (e.g. laser heat) at the exterior of the electrode assembly may be transferred to an undesired electrode to cause undesired welding. For example, a positive current collecting plate which should be welded to a positive electrode is welded to a negative electrode and results in short-circuiting of the secondary battery.

### SUMMARY OF THE INVENTION

A secondary battery is thus provided with a firm fixation between a lead element for collecting current and electrode assembly.

In one embodiment of the present invention, a secondary battery is provided having a lead element for collecting current that is stably connected to an electrode assembly without short-circuiting.

In one embodiment, a secondary battery, is provided which includes a case that houses an electrode assembly including a positive electrode, a negative electrode, and a separator interposed therebetween. A cap assembly seals the case and is electrically coupled to the electrode assembly. A current collecting plate is electrically coupled to the positive electrode or the negative electrode. That electrode is provided with an uncoated region, which does not include an active material, and which contacts the current collecting plate. The uncoated region is wider in a peripheral area of the electrode assembly than in the central area of the electrode assembly.

The uncoated region becomes wider as the uncoated region goes from the central area of the electrode assembly to the exterior area.

In one embodiment, both the positive and negative electrodes have uncoated regions that are positioned on opposite edges from each other in separate layers.

In one embodiment, a face of the uncoated region is bent toward the center of the electrode assembly to contact a face of the current collecting plate.

In another embodiment, the uncoated region becomes wider towards the peripheral area of the electrode assembly.

In another embodiment, a line defining an upper edge of the uncoated region is oblique relative to a lower edge of the electrode or is in a shape of a staircase.

### BRIEF DESCRIPTION OF THE DRAWINGS

The accompanying drawings illustrate exemplary embodiments of the present invention, and together with the description, serve to explain the principles of the present invention.

FIG. 1 is a cross-sectional view showing a secondary battery in accordance with an embodiment of the present invention.

FIG. 2 is a perspective view illustrating an electrode assembly in accordance with an embodiment of the present invention.

FIG. 3 is a plan view showing a positive electrode in accordance with an embodiment of the present invention.

FIG. 4 is a plan view showing a negative electrode in accordance with an embodiment of the present invention.

FIG. 5 illustrates a cross-section of an electrode in accordance with another embodiment of the present invention.

FIG. 6 is a schematic cross-sectional view illustrating an electrode assembly.

FIG. 7 is an enlarged perspective view illustrating fixation between an electrode assembly and a current collecting plate.

### DETAILED DESCRIPTION

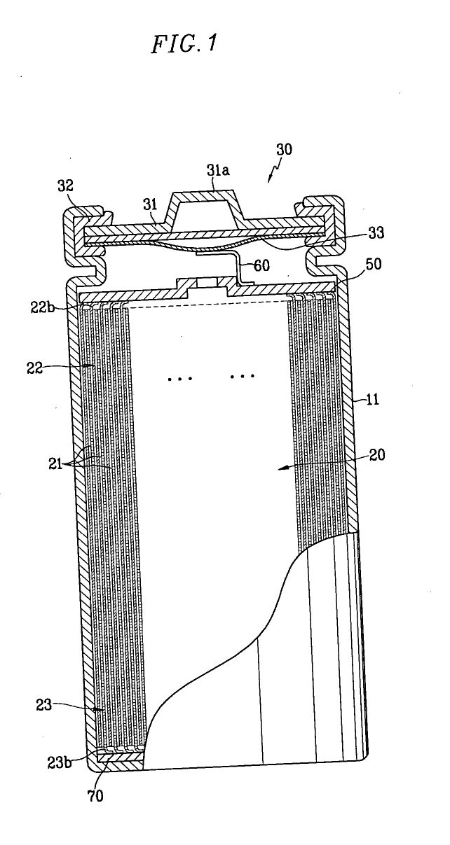

As shown in FIG. 1, a secondary battery is formed by putting an electrode assembly 20 into a cylindrical or hexahedral case 11, a part of which is open. The open part of the case 11 is then sealed with a cap assembly 30 through a gasket 32.

The case 11 is formed of conductive metal, such as aluminum, an aluminum alloy, or nickel-plated steel. In this embodiment, the case 11 is formed in a cylindrical shape having a space for housing the electrode assembly 20, but the present invention is not limited thereto.

The electrode assembly 20 is formed by interposing an insulating separator 21 between a positive electrode 22 and a negative electrode 23 and winding them. The positive electrode 22 and the negative electrode 23 have uncoated regions 22b, 23b respectively, which are respectively coupled with a positive current collecting plate 50 and a negative current collecting plate 70.

FIG. 1 illustrates an exemplary “jelly-roll” or spiral wound type electrode assembly 20, which is placed in a cylindrical case 11. However, other types of electrode assemblies are also within the scope of the invention.

A cap assembly 30 is provided with a cap plate 31 having an external terminal 31 a and the gasket 32 for insulating the case 11 from the cap plate 31. The cap assembly 30 includes a space for buffering internal pressure and it can further include a vent plate 33 having a safety vent which is broken down at a predetermined pressure level and releases gas to thereby prevent the battery from exploding. The safety vent is not limited to one formed in the vent plate 33 but any forms are possible as long as they can disconnect the electrode assembly 20 and the external terminal 31 electrically at the predetermined pressure level.

The gasket 32, which is formed of an insulating material, not only seals the case 11 but also electrically insulates the cap assembly 30 from the case 11. The cap assembly 30 acts as a positive electrode, and the case 11 acts as a negative electrode.

The cap assembly 30 is electrically connected to the electrode assembly 20 of the present invention through a lead line 60.

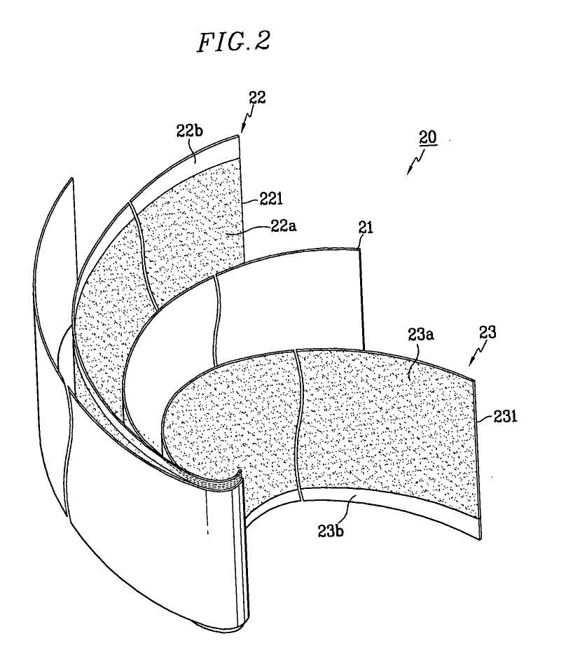

With reference to FIG. 2, the electrode assembly 20 is formed by interposing an insulating separator 21 between a positive electrode 22 and a negative electrode 23 and spiral-winding them. The positive electrode 22 and the negative electrode 23 are formed by coating the corresponding active materials on each current collector 221, 231. The active materials are not coated along one edge of the current collector which is formed of uncoated regions 22b, 23b respectively.

The positive uncoated region 22b and the negative uncoated region 23b are disposed on opposite edges of electrodes 22, 23. The edges extend past the respective upper and lower edges of the separator 21, when the electrode assembly is completed.

Referring to FIGS. 1 and 2, the positive uncoated region 22b of the electrode assembly 20 contacts a positive current collecting plate 50, and the negative uncoated region 23b contacts the negative current collecting plate 70. They are then electrically connected by coupling through a method such as laser welding.

In order to minimize contact resistance between the uncoated regions 23b, 22b and the current collecting plates 50, 70, the uncoated regions 22b, 23b are bent toward the center of the electrode assembly 20 so that the faces of the current collecting plates 50, 70 contact the faces of the uncoated regions 22b, 23b.

The heat generated during the welding between the uncoated regions 22b, 23b and the current collecting plates 50, 70 may dissolve the separator 21, causing the positive electrode 22 to contact the negative electrode 23 and to short-circuit the electrode assembly 20. This results from the contact area between the positive uncoated region 22b and the positive current collecting plate 50, and the contact area between the negative uncoated region 23b and the negative current collecting plate 70 at the peripheral area of the electrode assembly 20 being smaller than the contact areas in the center of the electrode assembly 20.

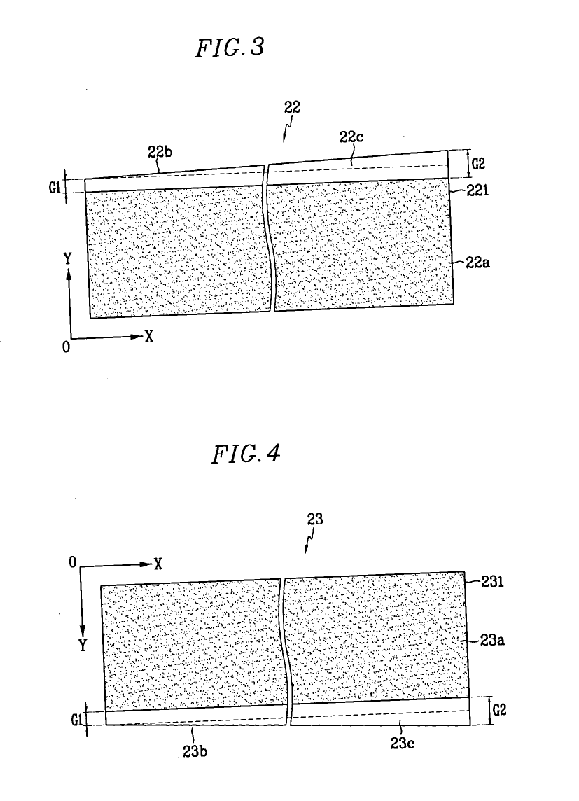

Referring to FIGS. 3-5, this problem is addressed. The uncoated region 22b formed along the edge of the positive electrode 22 has a width G1 at a central area of the electrode assembly 20, and a longer width G2 at a peripheral area of the electrode assembly 20.

The extended region 22c is formed along the longitudinal direction (along the X-axis) of the positive electrode 22 at the positive uncoated region 22b. The extended region 22c increases in area along the periphery of the electrode assembly 20. The extended region 22c emits the heat generated during welding for fixing the positive current collecting plate 50 onto the positive uncoated region 22b and thereby prevents excess heat from transfering to the separator 21.

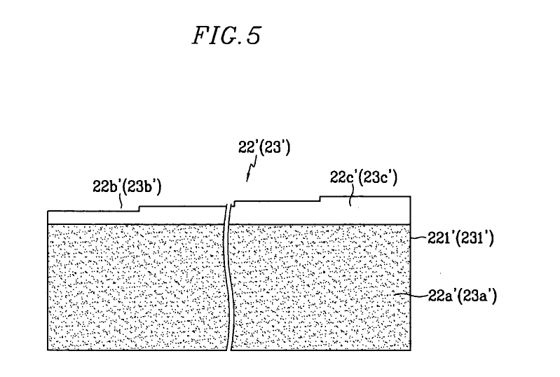

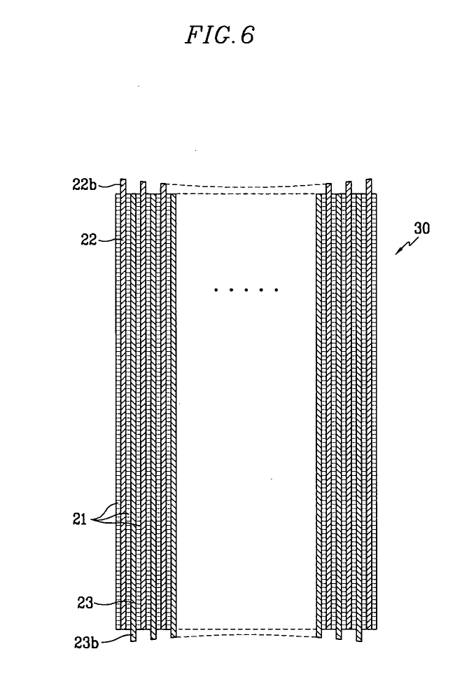

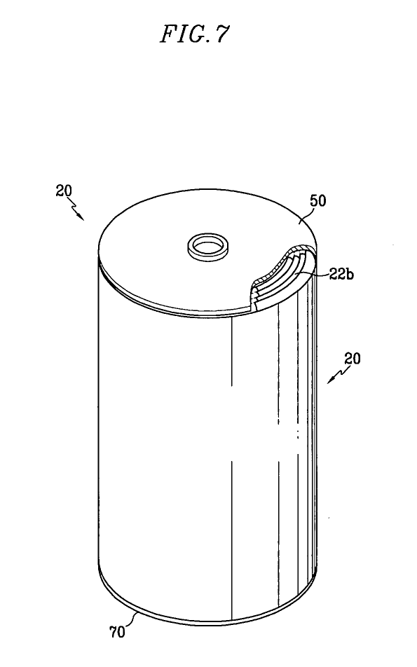

In one embodiment, the area of the extended region 22c becomes wider gradually as the uncoated region goes from the central area of the electrode assembly to the peripheral area in the X-axis direction shown in FIGS. 3 and 4. More particularly, the extended region 22c is formed so that a line defining an upper edge of the uncoated region is oblique relative to the lower edge of the electrode 22.

As shown in FIG. 4, an extended region 23c is formed at the negative uncoated region 23b of the negative electrode 23 in the same manner as described above in relation to the positive electrode 22.

According to another embodiment of the extended region which is shown in FIG. 5, the extended regions 22c′, 23c′ at the positive and negative uncoated regions 22b′, 23b′ of the positive and negative electrode 22′, 23′ is formed so that a line connecting points at both ends of the uncoated regions 22b′, 23b′ is formed in a shape of a staircase.

Referring again to FIGS. 1-4, the positive and negative electrodes 22, 23 having the extended regions 22c, 23c are interposed by a separator and spiral-wound as in a jelly-roll configuration to provide the electrode assembly 20. Based on the cross section of the electrode assembly 20, the positive and negative uncoated regions 22b, 23b are depressed toward the center in the center of the electrode assembly 20 (See FIGS. 1 and 7).

The current collecting plates 50, 70 thus contact the positive and negative uncoated regions 22b, 23b, that is both ends of the electrode assembly 20, and are fixed thereto. The uncoated region 22b, 23b are bent toward the center of the electrode assembly 20. The current collecting plates 50, 70 are put on top of the uncoated regions 22b, 23b which are bent toward the center of the electrode assembly 20 and the faces of the uncoated regions 22b, 23b contact the faces of the current collecting plates 50, 70. When the uncoated regions 22b, 23b contact the current collecting plates 50, 70 face to face, the current collecting plates 50, 70 are fixed onto the uncoated regions 22b, 23b through laser welding to thereby form the electrode assembly 20 (see FIG. 7). The extended regions 22c, 23c which contact the current collecting plates 50, 70 face-to-face compensate for the insufficient amounts of uncoated regions contacting the current collecting plates at the periphery of the electrode assembly 20, thereby emitting heat generated during welding to prevent dissolution of the separator.

The electrode assembly 20, fabricated in the above manner, and the current collecting plates are housed in the case 11 with the positive current collecting plate 50 facing upward. Therefore, the negative current collecting plate 70 connected to the negative electrode 23 contacts the bottom surface of the case 11, and the negative current collecting plate 70 is fixed onto the bottom surface of the case 11 through resistance welding. This way, case 11 acts as the anode of the battery.

Optionally, it is also possible to directly contact the negative uncoated region 23b to the case 11 without using the negative current collecting plate 70.

Electrolyte is supplied to the inside of the case 11 through an inlet (not shown) formed in the positive current collecting plate 50 to fill the electrode assembly 20. The positive current collecting plate 50 is electrically connected to the cap assembly 30 which is combined with the open part of the case 11 through a lead line 60. This way, the cap assembly 30 acts as the cathode of the battery and, accordingly, the secondary battery of the present embodiment is completed.

The contact area between the current collecting plate and the electrode assembly is widened as described above to thereby reduce the contact resistance, and fixation therebetween becomes firm to thereby increase the current collecting efficiency.

Such secondary batteries are useful as, for example, the power source for a driving motor that is used for electronic devices that require high power, such as electric vehicles, hybrid electric vehicles, wireless vacuum cleaners, motorbikes, and motor scooters.

While this invention has been described in connection with various embodiments, it is to be understood that the invention is not limited to the disclosed embodiments but, on the contrary, is intended to cover various modifications and equivalent arrangements included within the spirit and scope of the appended claims and equivalents thereof.

1. A secondary battery, comprising:
a case;
an electrode assembly including a positive electrode, a negative electrode, and a separator interposed therebetween and housed in the case;
a cap assembly sealing the case and electrically coupled to the electrode assembly; and
a current collecting plate,
wherein one of the positive electrode or the negative electrode is electrically coupled to the current collecting plate and is provided with an uncoated region, which does not include an active material, the uncoated region contacting the current collecting plate, and being wider in a peripheral area of the electrode assembly than in a central area of the electrode assembly.

2. The secondary battery of claim 1, further comprising a second collecting plate, wherein the other of the positive electrode or the negative electrode is provided with an uncoated region contacting the second collecting plate and being wider in the peripheral area of the electrode assembly than in the central area of the electrode assembly.

3. The secondary battery of claim 2, wherein the uncoated region of the positive electrode and the uncoated region of the negative electrode are positioned on opposite edges from each other in separate layers.

4. The secondary battery of claim 1, wherein the uncoated region becomes wider gradually as the uncoated region goes from the central area of the electrode assembly to the peripheral area.

5. The secondary battery of claim 1, wherein a face of the uncoated region is bent toward the center of the electrode assembly to contact a face of the current collecting plate.

6. The secondary battery of claim 4, wherein the uncoated region becomes wider toward the periphery of the electrode assembly.

7. The secondary battery of claim 6, wherein a line defining an upper edge of the uncoated region is oblique relative to a lower edge of the one of the positive electrode or the negative electrode.

8. The secondary battery of claim 6, wherein a line defining an upper edge of the uncoated region is in a shape of a staircase.

9. The secondary battery of claim 1, wherein the uncoated region and the current collecting plate are connected by welding.

10. The secondary battery of claim 1, wherein the electrode assembly has a jelly-roll configuration.

11. The secondary battery of claim 1, wherein the secondary battery is cylindrical battery.

12. The secondary battery of claim 1, wherein the secondary battery is a motor drive battery.

13. An electrode assembly comprising:
a positive electrode;
a negative electrode;
and a separator interposed between the positive electrode and the negative electrode,
wherein one of the positive electrode or the negative electrode is provided with an uncoated region, which does not include an active material, the uncoated region configured to contact a current collecting plate, and being wider in a peripheral area of the electrode assembly than in a central area of the electrode assembly.

14. The electrode assembly of claim 13, wherein the other of the positive electrode or the negative electrode is provided with an uncoated region configured to contact a second collecting plate, the uncoated region being wider in the peripheral area of the electrode assembly than in the central area of the electrode assembly.

15. The electrode assembly of claim 14, wherein the uncoated region of the positive electrode and the uncoated region of the negative electrode are positioned on opposite edges from each other in separate layers.

16. The electrode assembly of claim 13, wherein the uncoated region becomes wider gradually as the uncoated region goes from the central area of the electrode assembly to the peripheral area.

17. The electrode assembly of claim 13, wherein a face of the uncoated region is bent toward the center of the electrode assembly.

18. The electrode assembly of claim 13, wherein the uncoated region becomes wider toward the periphery of the electrode assembly.

19. The electrode assembly of claim 13, wherein a line defining an upper edge of the uncoated region is oblique relative to a lower edge of the one of the positive electrode and the negative electrode.

20. The electrode assembly of claim 13, wherein a line defining an upper edge of the uncoated region is in a shape of a staircase.
